(19) United States
(12) Patent Application Publication
(10) Pub. No.: US 2018/0068459 A1
(43) Pub. Date: Mar. 8, 2018

(54) Object Distance Estimation Using Data From A Single Camera

(71) Applicant: Ford Global Technologies, LLC, Dearborn, MI (US)

(72) Inventors: Yi Zhang, Sunnyvale, CA (US); Vidya Nariyambut Murali, Sunnyvale, CA (US); Madeline J. Goh, Palo Alto, CA (US)

(21) Appl. No.: 15/259,724

(22) Filed: Sep. 8, 2016

(51) Int. Cl. G06T 7/60; G06T 7/20; G01B 11/14; G05D 1/02

(52) U.S. Cl. CPC G06T 7/60; G06T 7/20; G06T 2207/20081; G05D 1/0238; G01B 11/14

(57) ABSTRACT

The disclosure relates to systems and methods for estimating or determining the motion of a vehicle and/or the distance to objects within view of a camera. A system for determining the motion of a vehicle includes a monocular camera mounted on a vehicle, an image component, a feature component, a model parameter component, a model selection component, and a motion component. The image component obtains a series of image frames captured by the monocular camera. The feature component identifies corresponding image features in adjacent image frames within the series of image frames. The model parameter component determines parameters for a planar motion model and a non-planar motion model based on the image features. The model selection component selects the planar motion model or the non-planer motion model as a selected motion model. The motion component determines camera motion based on parameters for the selected motion model.

### TECHNICAL FIELD

The present disclosure relates to vehicle speed estimation and object distance estimation and more particularly relates object distance estimation with ego-motion compensation using a monocular camera with for vehicle intelligence.

### BACKGROUND

Automobiles provide a significant portion of transportation for commercial, government, and private entities. Autonomous vehicles and driving assistance systems are currently being developed and deployed to provide safety features, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive and navigate a vehicle with little or no user input. However, due to the dangers involved in driving and the costs of vehicles, it is extremely important that autonomous vehicles and driving assistance systems operate safely and are able to accurately navigate roads in a variety of different driving environments.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a vehicle control system that includes an automated driving/assistance system, according to one embodiment;

FIG. 2 illustrates a perspective view of an example road environment;

FIG. 3 illustrates a perspective view of another example road environment;

FIG. 4 is a schematic diagram illustrating a projective transformation (homography), according to one embodiment;

FIG. 5 is a schematic diagram illustrating an epipolar geometry model to determine a fundamental matrix, according to one embodiment;

FIG. 6 is a schematic diagram illustrating temporal local bundle adjustment, according to one embodiment;

FIG. 7 is a diagram illustrating distance estimation, according to one embodiment;

FIG. 8 is a schematic block diagram illustrating data flow for a method of determining distance to an object, according to one embodiment;

FIG. 9 is a schematic block diagram illustrating example components of an object distance component, according to one implementation;

FIG. 10 is a schematic block diagram illustrating a method for determining camera motion, according to one implementation; and

FIG. 11 is a schematic block diagram illustrating a computing system, according to one implementation.

### DETAILED DESCRIPTION

An automated driving system or driving assistance system may use data from a plurality of sources during decision making, navigation, or driving to determine optimal paths or maneuvers. For example, an automated driving/assistance system may include sensors to sense a driving environment in real time and/or may access local or remote data storage to obtain specific details about a current location or locations along a planned driving path. For example, vehicles may encounter numerous objects, both static and dynamic. On top of detecting and classifying of such objects, the distance to the object can be important information for autonomous driving. An intelligent vehicle must be able to quickly respond according to the distance from the objects. Vehicle ego-motion (motion of the vehicle) estimation and accurate feature tracking using a monocular camera can be a challenging task in applications such as adaptive cruise control and obstacle avoidance.

In the present application, Applicants disclose systems, methods, and devices for estimating or otherwise determining the motion of a vehicle and/or the distance to objects within view of a camera. According to one embodiment, a system for determining the motion of a vehicle includes a monocular camera mounted on a vehicle, an image component, a feature component, a model parameter component, a model selection component, and a motion component. The image component is configured to obtain a series of image frames captured by the monocular camera. The feature component is configured to identify corresponding image features in adjacent image frames within the series of image frames. The model parameter component is configured to determine parameters for a planar motion model and a non-planar motion model based on the image features. The model selection component is configured to select one of the planar motion model and the non-planer motion model as a selected motion model. The motion component is configured to determine camera motion based on parameters for the selected motion model.

In one embodiment, images may be gathered from a monochrome or color camera attached to a vehicle. For example, the images may be gathered of a location in front of a vehicle so that decisions about driving and navigation can be made. In one embodiment, the system may include camera calibration data. For example, camera calibration may be pre-computed to improve spatial or color accuracy of images obtained using a camera. The system may use a deep neural network for object detection and localization. For example, the deep neural network may localize, identify, and/or classify objects within the 2D image plane using.

In one embodiment, the system calculates vehicle ego-motion based on images estimation camera motion estimation. For example, the system may perform feature extraction and matching with adjacent image frames (e.g., a first frame and second frame that were captured adjacent in time). Thus, features in each image may be associated with each other and may indicate an amount of movement by the vehicle. In one embodiment, the system may determine vehicle movement based on dynamic selection of motion models. In one embodiment, the system estimates parameters for a plurality of different motion models. For example, the system may estimate parameters for a homography matrix used for a planar motion model and for a fundamental matrix used for a non-planar motion model. When the parameters are estimated, the system may determine an optimal motion model by choosing the one that minimize a cost function. Using the selected motion model, the system estimates the camera/vehicle motion by decomposing the parameters. In one embodiment, the system reconstructs sparse feature points for 3D space. In one embodiment, the system performs image perspective transformations. In one embodiment, the system may apply bundle adjustment to further optimize the motion estimation system by leveraging temporal information from images, such as video.

Based on the ego-motion, the system may estimate/calculate an object distance for an object detected/localized by a neural network. In one embodiment, the system may estimate the object distance using a pinhole camera model.

The embodiments disclosed herein may incorporate all features that are presented image frames for more accurate and complete ego-motion, object distance estimations, and/or object tracking. For example, all features in images may be used for estimations and/or calculations, not just features that correspond to the ground or a driving surface. Embodiments also utilize sophisticated feature detection and description yielding more accurate feature correspondences.

Further embodiments and examples will be discussed in relation to the figures below.

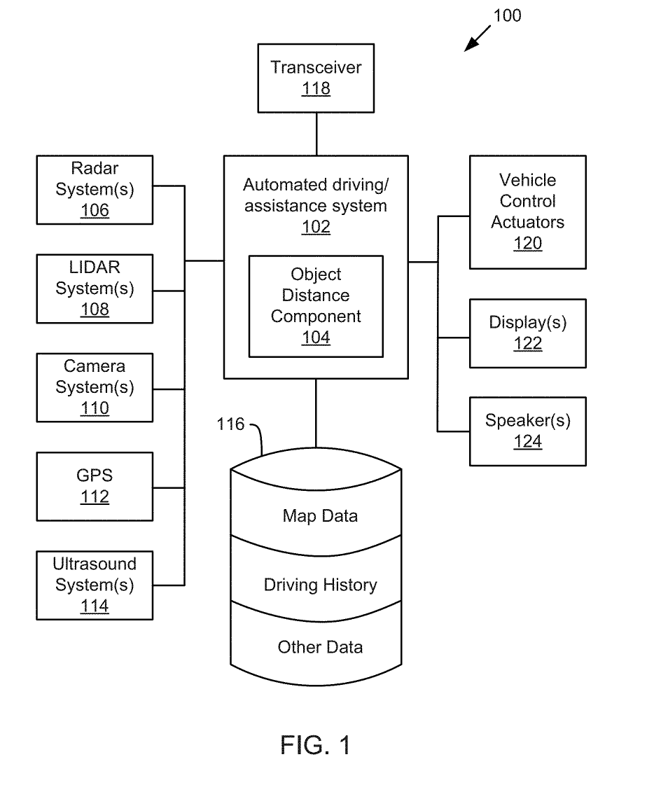

Referring now to the figures, FIG. 1 illustrates an example vehicle control system 100. The vehicle control system 100 includes an automated driving/assistance system 102. The automated driving/assistance system 102 may be used to automate or control operation of a vehicle or to provide assistance to a human driver. For example, the automated driving/assistance system 102 may control one or more of braking, steering, acceleration, lights, alerts, driver notifications, radio, or any other driving or auxiliary systems of the vehicle. In another example, the automated driving/assistance system 102 may not be able to provide any control of the driving (e.g., steering, acceleration, or braking), but may provide notifications and alerts to assist a human driver in driving safely. For example, the automated driving/assistance system 102 may include one or more controllers (such as those discussed herein) that provide or receive data over a controller bus and use the data to determine actions to be performed and/or provide instructions or signals to initiate those actions. The automated driving/assistance system 102 may include an object distance component 104 that is configured to detect and/or determine a distance to an object based on camera data.

The vehicle control system 100 also includes one or more sensor systems/devices for detecting a presence of nearby objects, lane markers, and/or or determining a location of a parent vehicle (e.g., a vehicle that includes the vehicle control system 100). For example, the vehicle control system 100 may include radar systems 106, one or more LIDAR systems 108, one or more camera systems 110, a global positioning system (GPS) 112, and/or ultrasound systems 114. The vehicle control system 100 may include a data store 116 for storing relevant or useful data for navigation and safety such as map data, a driving history (i.e., drive history), or other data. The vehicle control system 100 may also include a transceiver 118 for wireless communication with a mobile or wireless network, other vehicles, infrastructure, cloud or remote computing or storage resources, or any other communication system.

The vehicle control system 100 may include vehicle control actuators 120 to control various aspects of the driving of the vehicle such as electric motors, switches or other actuators, to control braking, acceleration, steering or the like. The vehicle control system 100 may include one or more displays 122, speakers 124, or other devices so that notifications to a human driver or passenger may be provided. A display 122 may include a heads-up display, dashboard display or indicator, a display screen, or any other visual indicator, which may be seen by a driver or passenger of a vehicle. The speakers 124 may include one or more speakers of a sound system of a vehicle or may include a speaker dedicated to driver notification. The vehicle control actuators 120, displays 122, speakers 124, or other parts of the vehicle control system 100 may be controlled by one or more of the controllers of the automated driving/assistance system 102.

In one embodiment, the automated driving/assistance system 102 is configured to control driving or navigation of a parent vehicle. For example, the automated driving/assistance system 102 may control the vehicle control actuators 120 to drive a path within lanes on a road, parking lot, driveway or other location. For example, the automated driving/assistance system 102 may determine a path based on information or perception data provided by any of the components 106-118. The sensor systems/devices 106-110 and 114 may be used to obtain real-time sensor data so that the automated driving/assistance system 102 can assist a driver or drive a vehicle in real-time. In one embodiment, the automated driving/assistance system 102 also uses information stored in a driving history (locally or remotely) for determining conditions in a current environment. The automated driving/assistance system 102 may implement one or more algorithms, applications, programs, or functionality that drive or assist in driving of the vehicle.

In one embodiment, the camera systems 110 include a front facing camera that is directed toward a region in front of the vehicle. The camera systems 110 may include cameras facing in different directions to provide different views and different fields of view for areas near or around the vehicle. For example, some cameras may face forward, sideward, rearward, at angles, or in any other direction.

It will be appreciated that the embodiment of FIG. 1 is given by way of example only. Other embodiments may include fewer or additional components without departing from the scope of the disclosure. Additionally, illustrated components may be combined or included within other components without limitation.

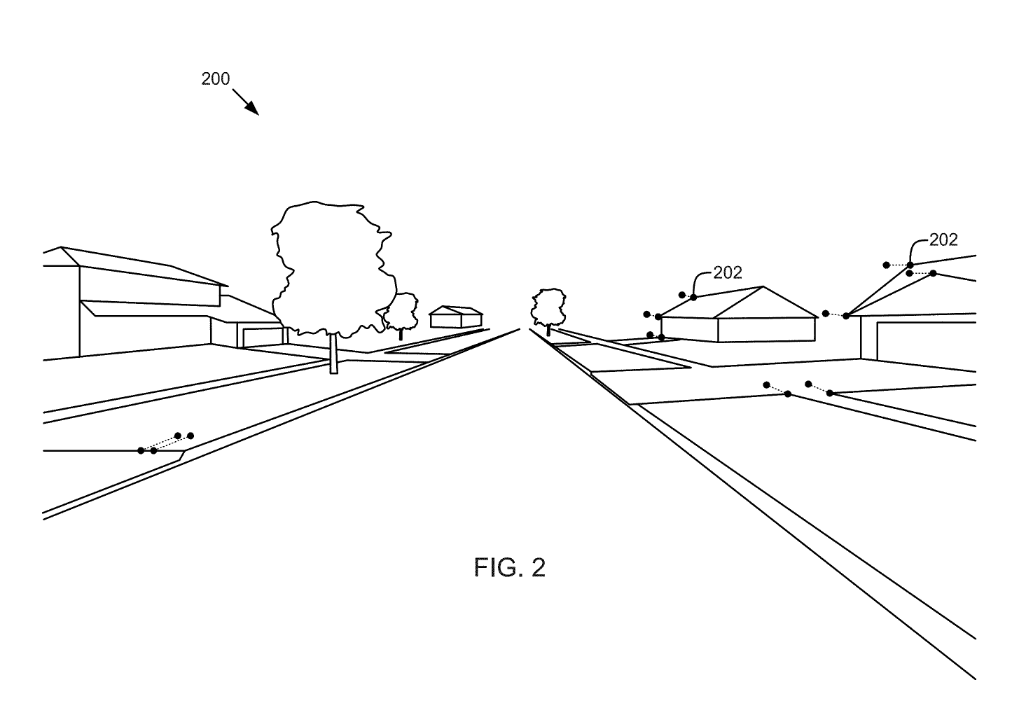

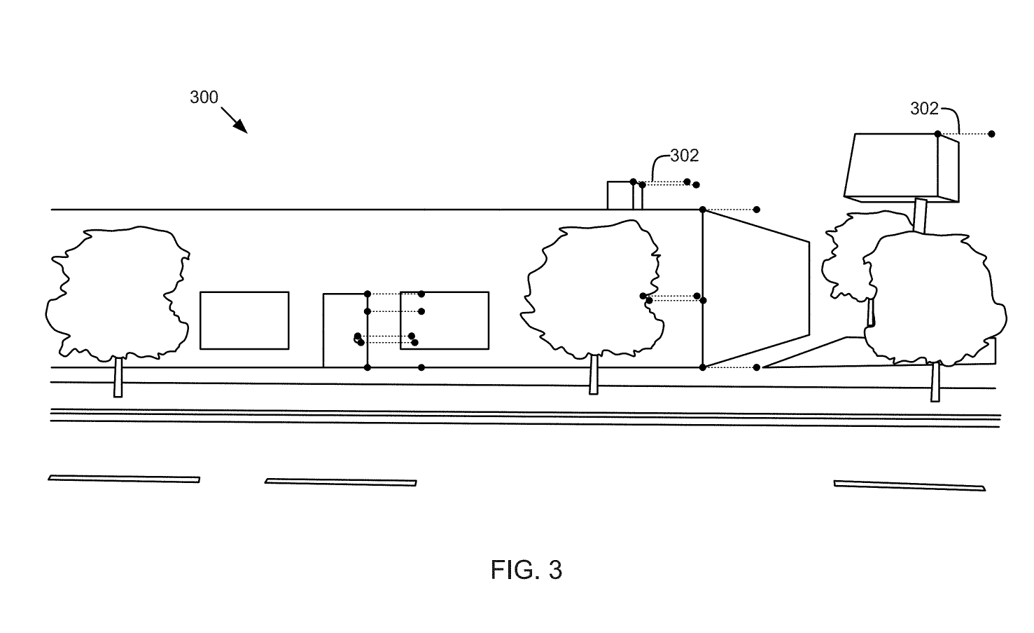

FIG. 2 illustrates an image 200 providing a perspective view of a roadway in a residential area, according to one embodiment. The view illustrates what may be captured in an image by a camera of a vehicle driving through a residential area. FIG. 3 illustrates an image 300 providing a perspective view of a roadway. The view illustrates what may be captured in an image by a camera of a vehicle driving through a “T” intersection. The image 200 represents a view where a non-planar motion model may provide more accurate results than a planar motion model. For example, objects or image features in view vary widely in their distance/depth from the camera. Thus, a planar motion model may not be able to accurately determine motion or movement of the camera (or vehicle) or objects within the image 200.

On the other hand, image 300 represents a view where a planar motion model may provide more accurate results than a non-planar motion model. For example, objects or image features in view do not vary significantly in their distance/depth from the camera. Thus, a planar motion model may be able to more accurately determine motion or movement of the camera (or vehicle) or objects within the image 200.

FIG. 2 includes dotted lines 202, which represent movement of detected features between the image 200 and a previous image. Similarly, FIG. 3 includes dotted lines 302, which represent movement of detected features between the image 300 and a previous image. In one embodiment, the object distance component 104 may use the fast and rotated brief (ORB) algorithm for detecting and correlating features within images. In one embodiment, the object distance component 104 performs image feature extraction for a current frame (e.g., 200 or 300) and an image previous to a current frame. The object distance component 104 may identify the features and correlate features in different images with each other. For example, the dotted lines 202 extend between a point that indicates a current location of the feature (i.e., in image 200) and a location for the feature in a previous image.

In one embodiment, the beginning and end points for each dotted line 202, 302 as well as the distance between the points may correspond to a distance traveled by an object or feature between images. In one embodiment, the positions and/or distance travelled by the points may be used to populate one or more motion models. For example, if a plurality of alternative motion models are available, the object distance component 104 may populate a matrix or fields for each motion model based on the positions and/or distances travelled. Based on this information, the object distance component 104 may select a motion model that best fits the data. For example, a cost function may calculate the error or cost for each motion model based on the populated values. The motion model with the smallest cost or error may then be selected as an optimal motion model for determining motion and/or distance for the specific images.

As will be understood by one of skill in the art FIGS. 2 and 3 are given by way of illustration. Additionally, dotted lines 202 are given by way of example only do not necessarily represent the features and/or correlations which may be identified. For example, a larger number of features, additional features, or different features may be detected and correlated in practice.

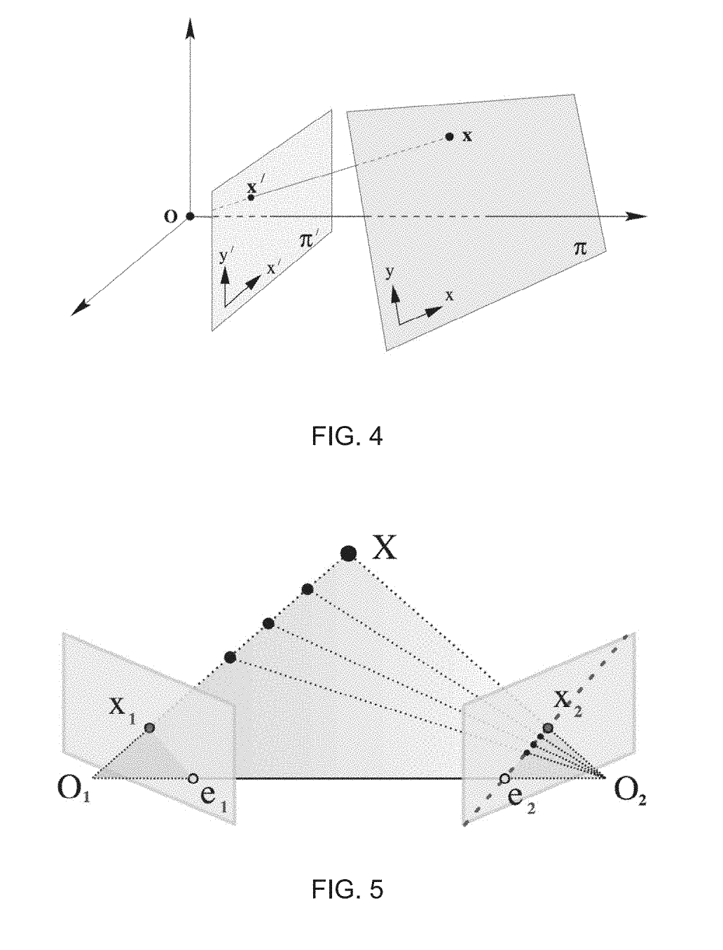

FIG. 4 is a diagram illustrating operation and/or calculation of a planar motion model. Planar motion models are used to approximate movement when feature points are located on or approximately on the same plane. For example, in images where there is very little variation in depth or distance from the camera, planar motion models may most accurately estimate motion of the ego-camera or ego-vehicle. Equation 1 below illustrates a homography transformation, which may be used for a planar motion model. It will be understood that Λ (lambda) represents a homography matrix, which can be solved for using the 4-points method.

x′=(KΛK⁻¹)x Equation 1

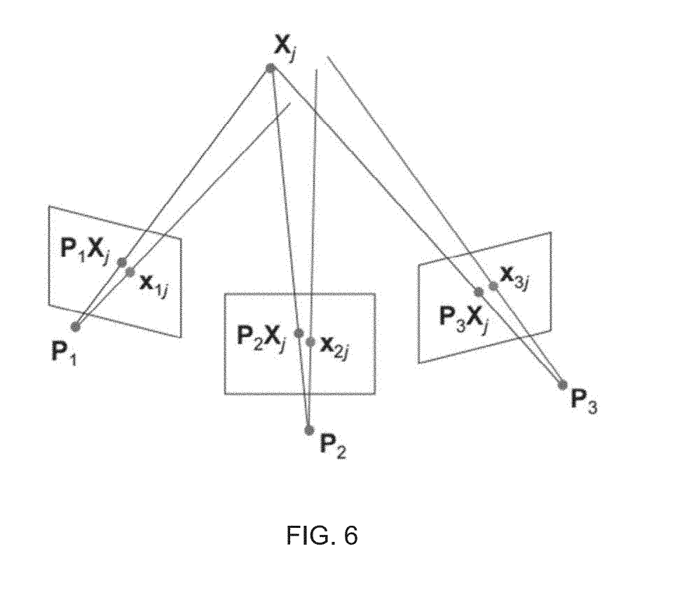

FIG. 5 is a diagram illustrating operation and/or calculation of a non-planar motion model. Non-planar motion models are used to approximate movement when feature points are located in three-dimensional space, and not located in or on approximately the same plane. For example, in images where there is a large amount of variation in depth or distance from the camera, non-planar motion models may most accurately estimate motion of the ego-camera or ego-vehicle. Equation 2 below illustrates a transformation for a fundamental matrix using epipolar geometry, which may be used for a non-planar motion model. It will be understood that F represents a fundamental matrix and can be solved for using the 8-points linear method or 8-points non-linear method.

x₂^{T}Fx₁=0 Equation 2

In one embodiment, temporal local bundle adjustment may be used to improve accuracy of feature correlation and/or parameter data for a fundamental and/or homography matrix. For example, noise from a camera image, error(s) in feature matching, and/or error in motion estimation can lead to inaccuracies in parameter data, motion estimation, and/or distance estimations for an object. Because the system has a plurality of frames, e.g., as part of a video or series of images captured by a camera, the system can perform bundle adjustment by incorporating temporal information from other image frames. For example, instead of just estimating motion from two consecutive frames, the system can incorporate information for a feature or object from a lot of frames within a time period (e.g., 1 or 2 seconds) to create average or filtered location or movement data to obtain information with reduced noise or lower the error. FIG. 6 and Equation 3 below illustrate one embodiment for temporal local bundle adjustment. For example, the filtered distance to a point or feature in an image may be computed by solving for D.

E(P,X)=Σᵢ₌₁^{m}Σⱼ₌₁ⁿD(xᵢⱼ,PᵢXⱼ)² Equation 3

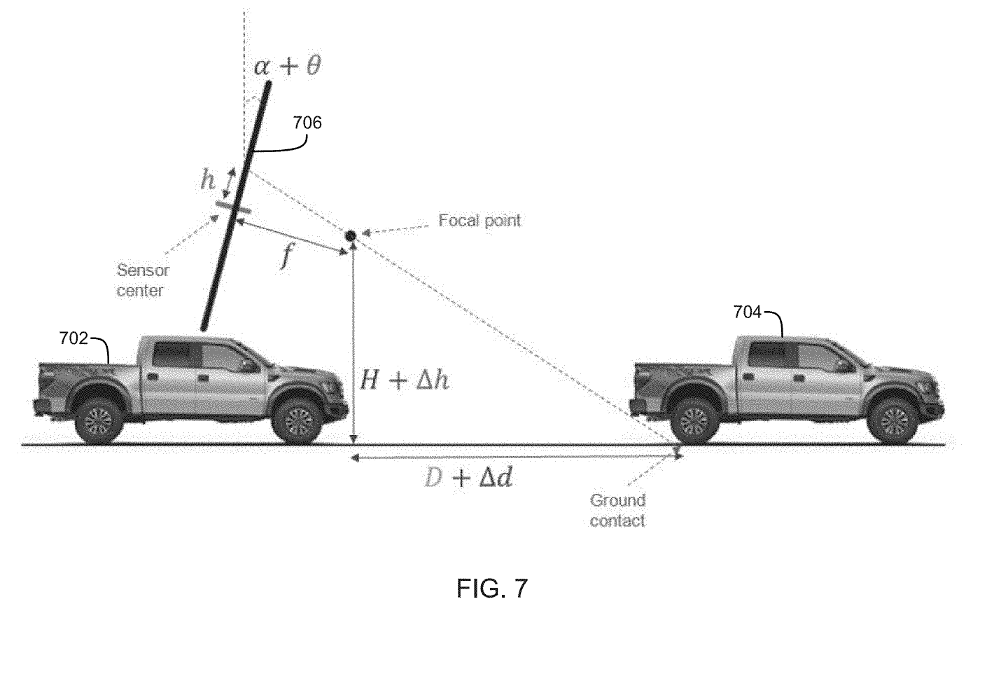

FIG. 7 is a diagram illustrating parameters for distance estimation, according to one embodiment. A first vehicle 702 (the ego-vehicle) is shown behind a second vehicle 704. An image sensor 706 of a camera is represented by a plane on which an image is formed. According to one embodiment, a distance between the second vehicle 704 and the camera or image sensor may be computed using Equation 4 below.

$$D = ( H + Δ h ) tan [ \frac{π}{2} - α - θ - {tan}^{- 1} \frac{h}{f} ] - Δ d \qquad Equation 4$$

The terms of Equation 4 and FIG. 7 are as follows: α represents the initial camera pitch with respect to the ego-vehicle (e.g., as mounted); f is the focal length for the camera; H is the initial camera height (e.g., as mounted); Δd is the camera to head distance (e.g., the distance between the focal point and the ground contact for the second vehicle 704); θ and Δh are obtained using the motion estimation from a motion model, such as a planar or non-planar motion model (θ represent the pitch of the vehicle and Δh represents the change in height for the object on the sensor); h is the contact point center distance (e.g., the distance between a specific pixel and the vertical sensor of a sensor array; and D is the distance to the object (e.g., distance to the ground contact point of the object).

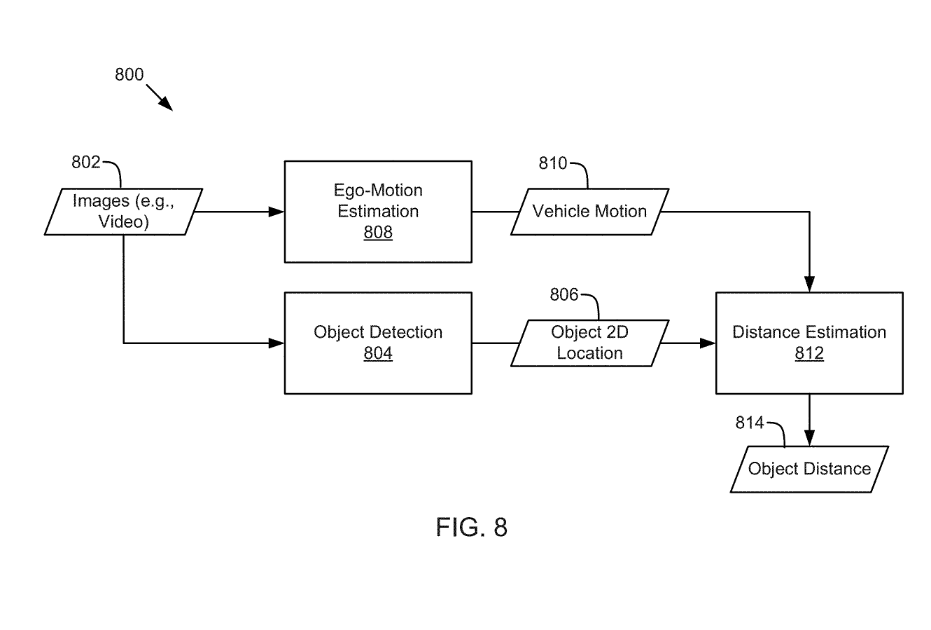

FIG. 8 is a schematic block diagram illustrating data flow for a method 800 of determining distance to an object based on a series of camera images. Images 802, such as images from a video feed, are provided for object detection 804. In one embodiment, object detection 804 detects objects within an image. For example, object detection 804 may produce an indication of a type or class of object and its two-dimensional location within each image. In one embodiment, object detection 804 is performed using a deep neural network into which an image is fed. Object detection 804 may result in an object 2D location 806 for one or more objects.

The images 802 are also provided for ego-motion estimation 808. Ego-motion estimation may include feature extraction and correlation, motion model selection, estimated vehicle motion, sparse feature points reconstruction, and local bundle adjustment, as discussed herein. In one embodiment, ego-motion estimation 808 may result in information about vehicle motion 810. The information about vehicle motion 810 may include information such as a distance traveled between frames or other indication of speed. The information about vehicle motion 810 may include information such as an offset angle for the camera, such as a tilt of the vehicle with respect to the road based on road slope at the location of the ego-vehicle or a reference object.

Distance estimation 812 is performed based on the vehicle motion and object 2D location 806. For example, distance estimation 812 may compute the distance between an ego-camera or ego-vehicle and an image feature or object. In one embodiment, distance estimation may be performed by correlating a pixel location of an object as determined through object detection 804 with a distance computed as shown and described in FIG. 7. Distance estimation 812 may result in an object distance 814 for a specific object detected during object detection 804. Based on the object distance, a control system of a vehicle such as the automated driving/assistance system 102 of FIG. 1, may make driving, navigation, and/or collision avoidance decisions.

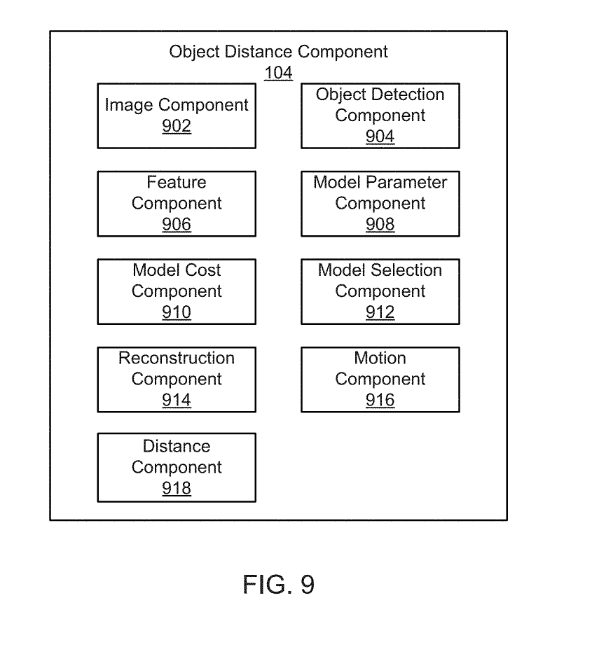

Turning to FIG. 9, a schematic block diagram illustrating components of an object distance component 104, according to one embodiment, is shown. The object distance component 104 includes an image component 902, an object detection component 904, a feature component 906, a model parameter component 908, a model cost component 910, a model selection component 912, a reconstruction component 914, a motion component 916, and a distance component 918. The components 902-918 are given by way of illustration only and may not all be included in all embodiments. In fact, some embodiments may include only one or any combination of two or more of the components 902-918. For example, some of the components 902-918 may be located outside the object distance component 104, such as within the automated driving/assistance system 102 or elsewhere.

The image component 902 is configured to obtain and/or store images from a camera of a vehicle. For example, the images may include video images captured by a monocular camera of a vehicle. The images may include images from a forward-facing camera of a vehicle. The images may be stored and/or receives as a series of images depicting a real-time or near real-time environment in front of or near the vehicle.

The object detection component 904 is configured to detect objects within images obtained or stored by the image component 902. For example, the object detection component 904 may process each image to detect objects such as vehicles, pedestrians, animals, cyclists, road debris, road signs, barriers, or the like. The objects may include stationary or moving objects. In one embodiment, the object detection component 904 may also classify an object as a certain type of object. Example object types may include a stationary object or mobile object. Other example object types may include vehicle type, animal, road or driving barrier, pedestrian, cyclist, or any other classification or indication of object type. In one embodiment, the object detection component 904 also determines a location for the object such as a two-dimensional location within an image frame or an indication of which pixels correspond to the object.

The feature component 906 is configured to detect image features within the images. The image features may include pixels located at high contrast boundaries, locations with high frequency content, or the like. For example, the boundaries of an object often have a high contrast with respect to a surrounding environment. Similarly, multi-colored objects may include high contrast boundaries within the same object. Corners of objects or designs on objects may be identified as image features. See, for example the dotted lines 202, 302 of FIGS. 2 and 3. In one embodiment, the feature component 906 detects all features within an image including those above a ground surface. For example, driving surfaces often have a smaller number of features than neighboring structures, shrubbery, or other objects or structures near a road or otherwise in view of a vehicle camera.

In one embodiment, the feature component 906 correlates features in an image or image frame with features in an adjacent image or image frame in a series of images. For example, during movement of a vehicle a feature corresponding to a corner of a building, vehicle, or other object may be at a different position in adjacent frames. The feature component 906 may correlate a feature corresponding to the corner located at a first position within a first image with a feature correspond to the same corner located at a second position within a second image. Thus, the same feature at different locations may be informative for computing the distance the vehicle traveled between the two frames. In one embodiment, the feature component 906 may identify and correlate features using an Oriented FAST and Rotated BRIEF (ORB) algorithm. In some embodiments, the ORB algorithm provides accurate feature detection and correlation with reduced delay. For example, the Speeded-Up Robust Features (SURF) algorithm can provide high accuracy but is slow. On the other hand the optical flow algorithm is fast but is prone to large motion errors. Applicants have found that the ORB algorithm provides a small accuracy tradeoff for large speed gains when performing feature selection and matching.

In one embodiment, when feature identification and matching has been performed, noise or error may be reduced by performing local bundle adjustment on image the features. For example, temporal information from a plurality of image frames (e.g., all image frame within one second or other time period) may be used to compute an a location for a feature in an image frame that provides for reduced noise, smoother motion, and/or reduced error.

The model parameter component 908 is configured to determine parameters for a plurality of motion models. For example, the model parameter component 908 may determine parameters for a planar motion model and a non-planar motion model based on the image features. The model parameter component 908 may populate a parameter matrix for the available motion models. For example, the model parameter component 908 may populate a homography matrix for a planar motion model and a fundamental matrix for a non-planar motion model. The values for the parameters may be computed based on the locations of features and distances between corresponding features between adjacent images.

The model cost component 910 is configured to calculate a cost for each of the motion models. For example, based on the parameters for a planar motion model and a non-planar motion model as determined by the model parameter component, the model cost component 910 may determine a cost or error for each motion model. The model cost component 910 may use a cost function for computing an error or other cost for each motion model.

The model selection component 912 is configured to select a motion model as an optimal motion model. The model selection component 912 may select a motion model for each set of adjacent images or frames. For example, the model selection component 912 may select either a planar motion model of a non-planer motion model as a selected or optimal motion model for a specific set of adjacent images.

In one embodiment, the model selection component 912 selects a motion model as an optimal model based on the motion model having the lowest cost or error. For example, the model selection component 912 may select a motion model that has the lowest cost as determined by the model cost component 910. In one embodiment, the model selection component 912 may select a motion model based on the amount of depth variation within the adjacent images. Generally features corresponding to objects or locations father away from a vehicle will move less between consecutive images than features or corresponding to objects or locations closer to the vehicle. In one embodiment, the cost computed by a cost function may indicate the amount of variation in the distances traveled by correlated features. For example, the cost function may indicate how well a motion model matches the amount of depth variation in a scene captured by the adjacent image frames. If the amount of depth variation in a scene captured by the adjacent image frames is low, for example, a planar motion model may be optimal. If the amount of depth variation in a scene captured by the adjacent image frames is high, on the other hand, the non-planar motion model may be optimal.

The reconstruction component 914 is configured to reconstruct a three-dimensional scene based on the selected motion model. In one embodiment, the reconstruction component 914 is configured to reconstruct three-dimensional sparse feature points based on the selected motion model. The reconstructed scene may include points corresponding to features detected by the feature component 906. In one embodiment, the reconstructed scene may then be used for distance estimation, obstacle avoidance, or other processing or decision making to be performed by a vehicle control system, such as an automated driving/assistance system 102.

The motion component 916 is configured to determine camera motion based on parameters for the selected motion model. For example, the motion component 916 may calculate a distance traveled by the camera (and corresponding vehicle) between the times when two consecutive images were captured. In one embodiment, the motion component 916 calculates θ, Δh, and/or Δd as shown and described in relation to FIG. 7 and Equation 4. In one embodiment, the motion component 916 determines movement of the vehicle solely based on image data from a single monocular camera. In one embodiment, the motion information may be used for distance estimation, obstacle avoidance, or other processing or decision making to be performed by a vehicle control system, such as an automated driving/assistance system 102.

The distance component 918 is configured to determine a distance between a camera or ego-vehicle and an object. For example, the distance component 918 may calculate the distance D of Equation 4 based on the selected motion model and corresponding parameters and motion information. The distance information may be used for obstacle avoidance, driving path planning, or other processing or decision making to be performed by a vehicle control system, such as an automated driving/assistance system 102.

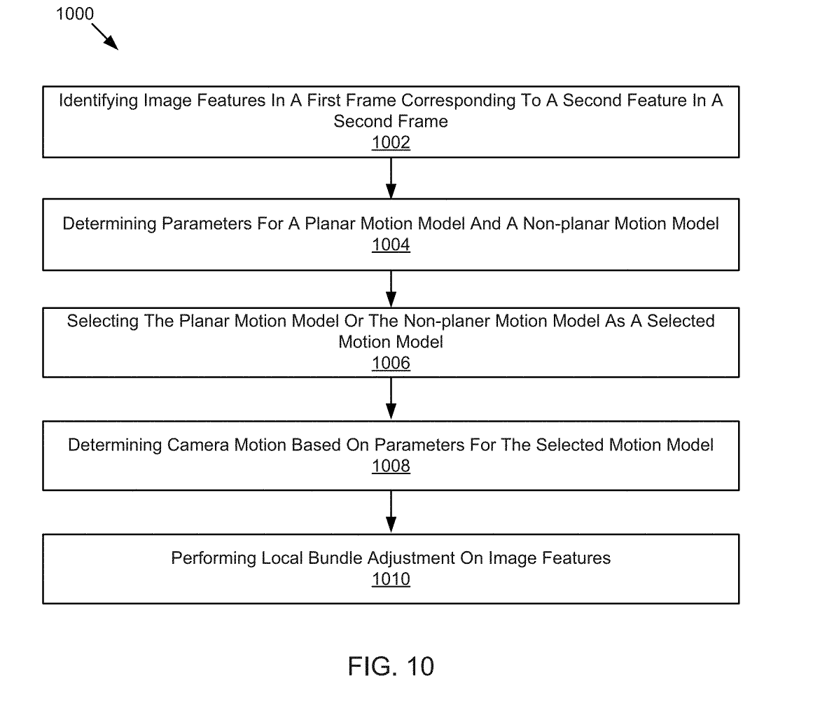

FIG. 10 is a schematic flow chart diagram illustrating a method 1000 for determining motion of a vehicle. The method 1000 may be performed by an object distance component such as the object distance component 104 of FIG. 1 or 9.

The method 1000 begins and a feature component 906 identifies at 1002 image features in a first frame corresponding to a second feature in a second frame. The first frame and the second frame include adjacent image frames captured by a camera. A model parameter component 908 determines at 1004 parameters for a planar motion model and a non-planar motion model. A model selection component 912 selects at 1006 the planar motion model or the non-planer motion model as a selected motion model. A motion component 916 determines at 1008 camera motion based on parameters for the selected motion model. In one embodiment, the feature component 906 performs 1010 local bundle adjustment on image features. For example, the bundle adjustments may be performed by incorporating information from multiple frame pairs to refine the camera ego-motion.

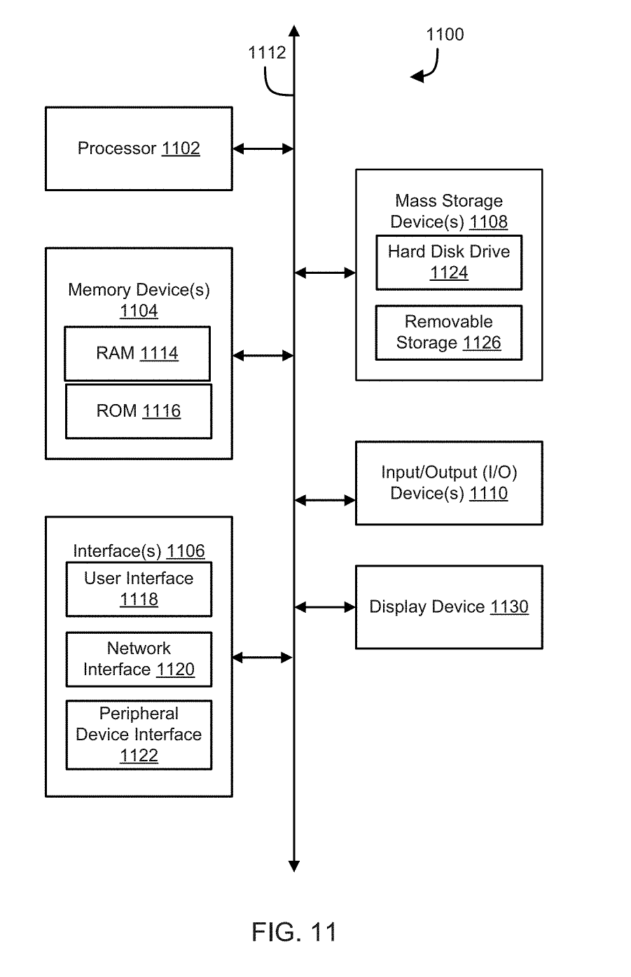

Referring now to FIG. 11, a block diagram of an example computing device 1100 is illustrated. Computing device 1100 may be used to perform various procedures, such as those discussed herein. Computing device 1100 can function as an object distance component 104, automated driving/assistance system 102, server, or any other computing entity. Computing device 1100 can perform various monitoring functions as discussed herein, and can execute one or more application programs, such as the application programs or functionality described herein. Computing device 1100 can be any of a wide variety of computing devices, such as a desktop computer, in-dash computer, vehicle control system, a notebook computer, a server computer, a handheld computer, tablet computer and the like.

Computing device 1100 includes one or more processor(s) 1102, one or more memory device(s) 1104, one or more interface(s) 1106, one or more mass storage device(s) 1108, one or more Input/Output (I/O) device(s) 1110, and a display device 1130 all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 11, a particular mass storage device is a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, and the like.

Display device 1130 includes any type of device capable of displaying information to one or more users of computing device 1100. Examples of display device 1130 include a monitor, display terminal, video projection device, and the like.

Interface(s) 1106 include various interfaces that allow computing device 1100 to interact with other systems, devices, or computing environments. Example interface(s) 1106 may include any number of different network interfaces 1120, such as interfaces to local area networks (LANs), wide area networks (WANs), wireless networks, and the Internet. Other interface(s) include user interface 1118 and peripheral device interface 1122. The interface(s) 1106 may also include one or more user interface elements 1118. The interface(s) 1106 may also include one or more peripheral interfaces such as interfaces for printers, pointing devices (mice, track pad, or any suitable user interface now known to those of ordinary skill in the field, or later discovered), keyboards, and the like.

Bus 1112 allows processor(s) 1102, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method that includes identifying image features in a first frame corresponding to a second feature in a second frame. The first frame and the second frame include adjacent image frames captured by a camera. The method includes determining parameters for a planar motion model and a non-planar motion model. The method includes selecting the planar motion model or the non-planer motion model as a selected motion model. The method also includes determining camera motion based on parameters for the selected motion model.

In Example 2, the method as in Example 1 further includes calculating a distance to an object or feature in the image frames based on the camera motion.

In Example 3, the method as in Example 2 further includes detecting and localizing one or more objects on a two-dimensional image plane using a deep neural network.

In Example 4, calculating the distance to the object or feature as in Example 3 includes calculating a distance to an object of the one or more objects.

In Example 5, the method as in any of Examples 1-4 further includes calculating a cost for each of the planar motion model and the non-planar motion model, wherein selecting one of the planar motion model and the non-planer motion model as the selected motion model comprises selecting the a model comprising a smallest cost.

In Example 6, selecting one of the planar motion model and the non-planer motion model as the selected motion model as in any of Examples 1-5 includes selecting based on the amount of depth variation in a scene captured by the adjacent image frames.

In Example 7, the method as in any of Examples 1-8 further includes reconstructing three-dimensional sparse feature points based on the selected motion model.

In Example 8, the method as in any of Examples 1-7 further includes performing local bundle adjustment on image features.

In Example 9, identifying corresponding image features in any of Examples 1-8 includes performing image feature extraction and matching using an ORB algorithm.

Example 10 is a system that includes a monocular camera mounted on a vehicle. The system also includes an image component, a feature component, a model parameter component, a model selection component, and a motion component. The image component is configured to obtain a series of image frames captured by the monocular camera. The feature component is configured to identify corresponding image features in adjacent image frames within the series of image frames. The model parameter component is configured to determine parameters for a planar motion model and a non-planar motion model based on the image features. The model selection component is configured to select one of the planar motion model and the non-planer motion model as a selected motion model. The motion component is configured to determine camera motion based on parameters for the selected motion model.

In Example 11, the system as in Example 10 further includes a distance component that is configured to calculate a distance to an object or feature in the image frames based on the camera motion.

In Example 12, the system as in any of Examples 10-11 further includes an object detection component configured to detect and localize one or more objects within the series of image frames using a deep neural network.

In Example 13, the system as in any of Examples 10-12 further includes a model cost component configured to calculate a cost for each of the planar motion model and the non-planar motion model. The model selection component is configured to select one of the planar motion model and the non-planer motion model as the selected motion model by selecting a model comprising a lowest cost.

In Example 14, the system as in any of Examples 10-13 further includes a reconstruction component configured to reconstruct three-dimensional sparse feature points based on the selected motion model.

In Example 15, identifying corresponding image features as in any of Examples 10-14 includes performing image feature extraction and matching using an ORB algorithm.

Example 16 is a computer readable storage media storing instructions that, when executed by one or more processors, cause the processors to identify corresponding image features in a first frame corresponding to a second feature in a second frame. The first frame and the second frame include adjacent image frames captured by a camera. The instructions further cause the one or more processors to determine parameters for a planar motion model and a non-planar motion model. The instructions further cause the one or more processors to select one of the planar motion model and the non-planer motion model as a selected motion model. The instructions further cause the one or more processors to determine camera motion based on parameters for the selected motion model.

In Example 17, the media as in Example 16 further stores instructions that cause the processor to calculate a distance to an object or feature in the image frames based on the camera motion.

In Example 18, the media as in Example 17 further stores instructions that cause the processors to detect and localize one or more objects on a two-dimensional image plane using a deep neural network. Calculating the distance to the object or feature includes calculating a distance to an object of the one or more objects.

In Example 19, the media as in any of Examples 16-18 further stores instructions that cause the processors to calculate a cost for each of the planar motion model and the non-planar motion model, wherein selecting one of the planar motion model and the non-planer motion model as the selected motion model comprises selecting the a model comprising a smallest cost.

In Example 20, the instructions as in any of Examples 16-19 cause the processors to identify corresponding image features by performing image feature extraction and matching using an ORB algorithm.

Example 21 is a system or device that includes means for implementing a method, system, or device as in any of Examples 1-20.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
identifying image features in a first frame corresponding to a second feature in a second frame, the first frame and the second frame comprising adjacent image frames captured by a camera;
determining parameters for a planar motion model and a non-planar motion model;
selecting the planar motion model or the non-planer motion model as a selected motion model; and
determining camera motion based on parameters for the selected motion model.

2. The method of claim 1, further comprising calculating a distance to an object or feature in the image frames based on the camera motion.

3. The method of claim 2, further comprising detecting and localizing one or more objects on a two-dimensional image plane using a deep neural network.

4. The method of claim 3, wherein calculating the distance to the object or feature comprises calculating a distance to an object of the one or more objects.

5. The method of claim 1, further comprising calculating a cost for each of the planar motion model and the non-planar motion model, wherein selecting one of the planar motion model and the non-planer motion model as the selected motion model comprises selecting a model comprising a smallest cost.

6. The method of claim 1, wherein selecting one of the planar motion model and the non-planer motion model as the selected motion model comprises selecting based on an amount of depth variation in a scene captured by the adjacent image frames.

7. The method of claim 1, further comprising reconstructing three-dimensional sparse feature points based on the selected motion model.

8. The method of claim 1, further comprising performing local bundle adjustment on image features.

9. The method of claim 1, wherein identifying corresponding image features comprises performing image feature extraction and matching using an Oriented FAST and Rotated BRIEF (ORB) algorithm.

10. A system comprising:
a monocular camera mounted on a vehicle;
an image component to obtain a series of image frames captured by the monocular camera;
a feature component configured to identify corresponding image features in adjacent image frames within the series of image frames;
a model parameter component configured to determine parameters for a planar motion model and a non-planar motion model based on the image features;
a model selection component configured to select one of the planar motion model and the non-planer motion model as a selected motion model; and
a motion component configured to determine camera motion based on parameters for the selected motion model.

11. The system of claim 10, further comprising a distance component configured to calculate a distance to an object or feature in the image frames based on the camera motion.

12. The system of claim 11, further comprising an object detection component configured to detect and localize one or more objects within the series of image frames using a deep neural network.

13. The system of claim 10, further comprising a model cost component configured to calculate a cost for each of the planar motion model and the non-planar motion model, wherein the model selection component is configured to select one of the planar motion model and the non-planer motion model as the selected motion model by selecting a model comprising a lowest cost.

14. The system of claim 10, further comprising a reconstruction component configured to reconstruct three-dimensional sparse feature points based on the selected motion model.

15. The system of claim 10, wherein identifying corresponding image features comprises performing image feature extraction and matching using an Oriented FAST and Rotated BRIEF (ORB) algorithm.

16. Computer readable storage media storing instructions that, when executed by one or more processors, cause the processors to:
identify corresponding image features in a first frame corresponding to a second feature in a second frame, wherein the first frame and the second frame comprise adjacent image frames captured by a camera;
determine parameters for a planar motion model and a non-planar motion model;
selecting one of the planar motion model and the non-planer motion model as a selected motion model; and
determining camera motion based on parameters for the selected motion model.

17. The computer readable media of claim 16, the media further storing instructions that cause the processor to calculate a distance to an object or feature in the image frames based on the camera motion.

18. The computer readable media of claim 17, the media further storing instructions that cause the processors to detect and localize one or more objects on a two-dimensional image plane using a deep neural network, wherein calculating the distance to the object or feature comprises calculating a distance to an object of the one or more objects.

19. The computer readable media of claim 16, the media further storing instructions that cause the processors to calculate a cost for each of the planar motion model and the non-planar motion model, wherein selecting one of the planar motion model and the non-planer motion model as the selected motion model comprises selecting a model comprising a smallest cost.

20. The computer readable media of claim 16, wherein the instructions cause the processors to identify corresponding image features by performing image feature extraction and matching using an Oriented FAST and Rotated BRIEF (ORB) algorithm.
